(19) United States
(12) Patent Application Publication
(10) Pub. No.: US 2026/0336226 A1
(43) Pub. Date: Oct. 29, 2026

(54) BLOCKCHAIN-INTEGRATED 3D PRINTING SYSTEM WITH EMBEDDED WALLET AND NFT-GATED MANUFACTURING CONTROL

(71) Applicant: Jon Zachary Williams, Austin, TX (US)

(72) Inventor: Jon Zachary Williams, Austin, TX (US)

(21) Appl. No.: 19/656,922

(22) Filed: Apr. 23, 2026

Related U.S. Application Data
(60) Provisional application No. 63/793,233, filed on Apr. 23, 2025.

(51) Int. Cl. B29C 64/393; B33Y 50/02; G06Q 20/36; G06Q 20/38; G06Q 20/40; H04L 9/00; H04L 9/08; H04L 9/32

(52) U.S. Cl. CPC B29C 64/393; B33Y 50/02; G06Q 20/36; G06Q 20/3823; G06Q 20/401; H04L 9/0825; H04L 9/3213; H04L 9/3247; H04L 9/50

(57) ABSTRACT

A blockchain-integrated manufacturing system includes a 3D printer having a secure controller, a non-removable embedded wallet integrated with the secure controller, a blockchain daemon operatively associated with the secure controller and configured to validate non-fungible-token-based digital licenses through on-chain verification on a blockchain network, a secure file decryption module configured to decrypt encrypted manufacturing files upon successful license validation, a manufacturing mechanism, and a motion controller coupled to the secure controller through an isolated communication bus. Cryptographic credentials of the embedded wallet reside in a secure key storage from which private keys are not extractable, and decrypted toolpath data is confined to an isolated execution environment. Upon completion of an authorized manufacturing operation, the embedded wallet constructs and submits transactions to the blockchain network effecting royalty distribution and burning, decrementing, or transferring the digital license, permitting autonomous per-print authorization and settlement without reliance on a third-party licensing server.

### CROSS-REFERENCE TO RELATED APPLICATION

This application claims the benefit of priority under 35 U.S.C. § 119(e) to U.S. Provisional Patent Application No. 63/793,233, filed Apr. 23, 2025, and entitled “Blockchain-Integrated 3D Printing System with Embedded Wallet and NFT-Gated Manufacturing Control,” the entire disclosure of which is incorporated herein by reference.

### BACKGROUND OF THE INVENTION

### 1. Field of Invention

The present invention relates to networked manufacturing systems, and more particularly to network-connected manufacturing devices incorporating integrated blockchain technology for secure manufacturing control and intellectual property rights enforcement across data networks.

### 2. Description of Related Art

Modern 3D printers are networked computing devices that participate in one or more data networks and that receive, transmit, and process digital design data over those networks during ordinary operation. A typical 3D printer comprises one or more network interfaces, including Ethernet, wireless local area network interfaces conforming to an IEEE 802.11 standard, personal area network interfaces, cellular network interfaces, and universal serial bus interfaces for local tethering, through which the printer communicates with host computers, cloud-based print management services, firmware and slicer update servers, material-supplier authentication endpoints, remote monitoring services, and, in industrial deployments, manufacturing execution systems operating over protocols such as MTConnect, OPC Unified Architecture, and MQTT. In distributed manufacturing deployments, print jobs are routed among geographically dispersed printers through networked infrastructure based on availability, capability, cost, and proximity to the end user. Design files representing protectable intellectual property of design creators traverse these networks in the course of each such deployment, and the printers receiving those files are addressable network endpoints reachable by remote parties.

Conventional 3D printers, despite operating in this networked computing environment, function as untrusted execution environments with respect to the digital designs they reproduce. A printer receives a stereolithography (“STL”) file or G-code instructions from a host computer or network service and executes those instructions without any cryptographic verification of the right to manufacture the object represented by the instructions. These problems arise from the computerized and networked architecture of modern additive manufacturing devices themselves, in which design data traverses general-purpose computing systems and public or semi-public networks in decrypted form, and in which the printing device lacks the cryptographic capabilities necessary to verify its own authority to execute manufacturing instructions.

This architecture creates several technical problems specific to the operation of networked 3D printers. First, because the printer does not participate in authorization, any enforcement of manufacturing rights must occur upstream on general-purpose computers running conventional operating systems, where decrypted toolpath data is exposed to host-level processes and to the networks traversed by those processes, and can be captured, duplicated, and redistributed. Second, conventional printers have no cryptographic identity of their own and therefore cannot attest, to a remote party or to any other network peer, that a particular print operation was performed on an authorized device running unmodified firmware. Third, existing digital rights management (“DRM”) schemes for additive manufacturing rely on centralized licensing servers reached over the network, which constitute single points of failure, which require continuous network connectivity to servers controlled by a single vendor, and which expose manufacturing authorization decisions to the availability and policies of third-party intermediaries. Fourth, conventional printers cannot produce tamper-evident on-device records of manufacturing events, and therefore cannot serve as trusted reporting endpoints within a networked accounting architecture; existing accounting systems rely on off-device records vulnerable to tampering and reconciliation disputes. Fifth, as networked endpoints, conventional printers are subject to remote probing, unauthorized access, and firmware modification by remote parties, yet have no cryptographic means of detecting such modification or of refusing to execute manufacturing operations when their own integrity has been compromised. These deficiencies are inherent in the architecture by which conventional 3D printers receive and execute manufacturing instructions over data networks, and cannot be remedied by modifications to human licensing practices or business arrangements alone.

A need exists in the art for a networked 3D printing architecture that resolves the foregoing technical deficiencies by enabling the printer itself to participate in authorization of each manufacturing operation as a cryptographically identified network peer, by protecting cryptographic key material against extraction from the device, by confining decrypted toolpath data to a secure execution environment inaccessible to host-level processes and to the networks to which the printer is connected, by providing the printer with a cryptographic identity capable of attesting to the integrity of its firmware and the authenticity of its manufacturing operations to remote verifiers, and by eliminating reliance on centralized third-party licensing servers and continuous network connectivity to such servers for authorization decisions.

### SUMMARY OF THE INVENTION

The present invention addresses these technical problems by modifying the manufacturing device itself. Rather than treating the device as a passive executor of external instructions, embodiments of the invention integrate cryptographic identity, secure decryption authority, and autonomous verification logic directly into the device's hardware and firmware, such that a decision to manufacture a specific object is made by the device using cryptographic proofs that cannot be forged or replayed. This hardware-rooted architecture can produce concrete technical improvements over conventional 3D printing systems. In certain embodiments, private cryptographic keys cannot be extracted from the device without physically destroying it; decrypted toolpath data need not exist outside a secure execution environment and is accordingly not exposed to host-level capture; and authorization decisions require no trust in, and no network connectivity to, any third-party licensing server. The blockchain-integrated 3D printing device includes an onboard cryptographic wallet, blockchain transaction capabilities, and a native software daemon configured to enable the device to autonomously verify digital licenses, such as non-fungible tokens, on a blockchain network prior to executing a print. The device restricts or grants manufacturing operations based on an on-chain state of one or more digital assets and enforces usage limits, royalty distributions, and eco-incentivized behaviors through one or more smart contracts.

In an embodiment of the invention, a blockchain-integrated manufacturing system comprises: a secure controller; a non-removable embedded wallet integrated with said secure controller; a blockchain daemon operatively associated with said secure controller and configured to validate non-fungible-token-based digital licenses through verification on a blockchain network; a secure file decryption module configured to decrypt encrypted manufacturing files upon successful validation of said non-fungible-token-based digital licenses by said blockchain daemon; a manufacturing mechanism configured to perform manufacturing operations; and a motion controller coupled to said secure controller through an isolated communication bus and configured to drive said manufacturing mechanism based on a blockchain validation status determined by said blockchain daemon. The non-removable embedded wallet may comprise: a secure key storage configured to store cryptographic credentials of said non-removable embedded wallet; a blockchain network interface; a smart contract interaction module configured to construct and submit transactions to one or more smart contracts deployed on said blockchain network; and an automated royalty distribution module configured to construct transactions distributing payment among a plurality of recipients in accordance with a royalty policy associated with a manufacturing operation. The secure key storage may be implemented through at least one of file system encryption of a protected key store maintained by said secure controller, or a trusted platform module. The secure key storage may comprise a hardware security module physically separate from a main enclosure of said system and coupled to said secure controller through a hardware interface, said hardware security module being cryptographically paired with said secure controller at initial provisioning such that said hardware security module refuses to perform cryptographic operations for any secure controller other than said secure controller with which said hardware security module was originally paired. The blockchain daemon may comprise: a remote procedure call client configured to connect to a remote procedure call network of said blockchain network; non-fungible-token validation logic configured to verify said non-fungible-token-based digital licenses; an encrypted file management module; and an automated token operations module configured to track usage of said non-fungible-token-based digital licenses. The blockchain network may be a Solana blockchain network and said remote procedure call network is the Solana remote procedure call network. The filament authentication subsystem may be configured to verify one or more properties of a filament loaded into said manufacturing mechanism, wherein said non-removable embedded wallet is further configured to submit to a smart contract on said blockchain network an on-chain transaction distributing an eco-incentive reward upon successful verification of said filament as belonging to an eco-incentivized class. The non-removable embedded wallet may further comprise a token burn and settlement module configured to, upon completion of a manufacturing operation authorized by said blockchain daemon, construct and submit a transaction to said blockchain network effecting an operation selected from the group consisting of burning said non-fungible-token-based digital license, decrementing an on-chain usage counter associated with said non-fungible-token-based digital license, and transferring said non-fungible-token-based digital license to a terminal wallet address controlled by a smart contract.

In another embodiment of the invention, a method for blockchain-validated manufacturing performed by a blockchain-integrated manufacturing system comprising a secure controller, a non-removable embedded wallet integrated with said secure controller, and a manufacturing mechanism, the method comprises: receiving, by said secure controller, an encrypted manufacturing file and a reference to a non-fungible-token-based digital license; validating, by a blockchain daemon operatively associated with said secure controller, said non-fungible-token-based digital license through verification on a blockchain network; decrypting, by said secure controller, said encrypted manufacturing file upon successful validation of said non-fungible-token-based digital license; executing, by said manufacturing mechanism, a manufacturing operation using decrypted toolpath data from said encrypted manufacturing file received from said secure controller over an isolated communication bus; and processing, by said non-removable embedded wallet, an automated royalty payment through a smart contract deployed on said blockchain network. The method may further comprise tracking, by said secure controller, usage limits associated with said non-fungible-token-based digital license through on-chain token operations, and submitting an automated token burn transaction upon completion of said manufacturing operation. The method may further comprise verifying, by said secure controller, a property of a filament loaded into said manufacturing mechanism, and submitting by said non-removable embedded wallet an on-chain transaction distributing an environmental compliance incentive through a smart contract based on said verifying. The method may further comprise maintaining a secure record of said manufacturing operation by producing, by said blockchain daemon upon said validating, a signed attestation binding said manufacturing operation to a mint address of said non-fungible-token-based digital license, a public key of said non-removable embedded wallet, and an ordinal of said blockchain network at which said validating succeeded. The method may further comprise validating comprises submitting, by said blockchain daemon, at least one account-lookup query to said blockchain network and accepting only account states having a commitment level of confirmed or finalized. The method may further comprise, during execution of said manufacturing operation, performing, by said blockchain daemon, periodic re-verification of ownership of said non-fungible-token-based digital license at configured intervals and interrupting said manufacturing operation in response to failure of any re-verification.

In another embodiment of the invention, a non-transitory computer-readable medium storing instructions that, when executed by one or more processors of a secure controller, cause said secure controller to: validate a non-fungible-token-based digital license through on-chain verification on a blockchain network; decrypt an encrypted manufacturing file upon successful validation of said non-fungible-token-based digital license; direct a manufacturing mechanism to execute a manufacturing operation using decrypted toolpath data from said encrypted manufacturing file, said decrypted toolpath data being transmitted from said secure controller over an isolated communication bus; submit to a smart contract deployed on said blockchain network a transaction effecting an automated royalty payment upon completion of said manufacturing operation; and track permissions associated with said non-fungible-token-based digital license through on-chain token operations. The instructions are stored in encrypted form and decrypted at load time using a key released from a secure key storage only upon successful measured-boot attestation of firmware of said secure controller. The instructions further cause said secure controller to distribute said automated royalty payment among a plurality of recipients including at least two of a primary creator, a collaborating creator, a platform operator, and a distributor, in accordance with a royalty policy associated with said non-fungible-token-based digital license. The instructions further cause said secure controller to verify a property of a filament loaded into said manufacturing mechanism and to submit to a smart contract on said blockchain network a transaction distributing an eco-incentive reward upon successful verification of said filament as belonging to an eco-incentivized class. The instructions further cause said secure controller to, upon completion of said manufacturing operation, construct and submit to said blockchain network a transaction effecting an operation selected from the group consisting of burning said non-fungible-token-based digital license, decrementing an on-chain usage counter associated with said non-fungible-token-based digital license, and transferring said non-fungible-token-based digital license to a terminal wallet address controlled by a smart contract. The instructions further cause said secure controller to operate in a deferred-settlement mode during periods of intermittent connectivity to said blockchain network, in which verification attestations produced upon successful validation of said non-fungible-token-based digital license are cached locally and settlement transactions are queued and transmitted to said blockchain network upon restoration of connectivity, subject to a maximum offline interval beyond which cached attestations are invalidated, said maximum offline interval being settable by at least one of a governing smart contract of said blockchain network, a license-issuing authority, and a printer operator.

The disclosed architecture provides several advantages over conventional 3D printing and digital rights management systems. By relocating license verification and file decryption from a host computer or a remote licensing server to the manufacturing device itself, embodiments of the invention eliminate entire categories of attack that have historically undermined digital manufacturing workflows, including host-side memory capture of decrypted toolpaths, man-in-the-middle interception of unencrypted print data traversing a local network, and circumvention of license checks performed by software running outside a trusted execution environment. Because private cryptographic keys are generated within, and never leave, a secure key storage of the device, possession of a valid license to print a given object cannot be transferred merely by copying files, and a compromised host computer cannot be leveraged to produce unauthorized physical articles.

Further advantages flow from the on-chain character of the authorization and settlement logic. Royalty distributions, usage decrements, token burns, and eco-incentive payouts are constructed and signed by the device itself and submitted directly to a blockchain network, so creators, licensors, and other stakeholders receive consideration contemporaneously with the manufacturing event rather than through periodic reporting or audit of a centralized intermediary. The device can continue to authorize printing during periods of intermittent connectivity through locally-cached verification attestations bounded by a configurable offline interval, and governance parameters such as royalty splits, eco-incentive rates, and the offline interval itself may be administered through a smart contract, permitting license terms to evolve over the life of a digital asset without reissuing the asset or reflashing the device. Collectively, these features enable a manufacturing ecosystem in which the physical act of fabrication is cryptographically bound to a verifiable on-chain right to fabricate, with economic and compliance consequences that follow automatically and transparently from each print.

Other devices, apparatus, systems, methods, features, and advantages of the invention will become apparent to one with skill in the art upon examination of the following figures and detailed description. It is intended that all such additional systems, methods, features, and advantages be included within this description, the scope of the invention, and protected by the accompanying claims.

### BRIEF DESCRIPTION OF THE DRAWINGS

For a complete understanding of the present invention and its advantages, reference is now made to the ensuing descriptions taken in connection with the accompanying drawings briefly described as follows.

FIG. 1 illustrates a schematic of a blockchain-integrated 3D printing system architecture according to an embodiment of the invention.

FIG. 2 illustrates the non-removable embedded wallet and its constituent modules according to an embodiment of the invention.

FIG. 3 illustrates a non-fungible-token-gated manufacturing authorization and execution flow according to an embodiment of the invention.

### DETAILED DESCRIPTION OF PREFERRED EMBODIMENTS

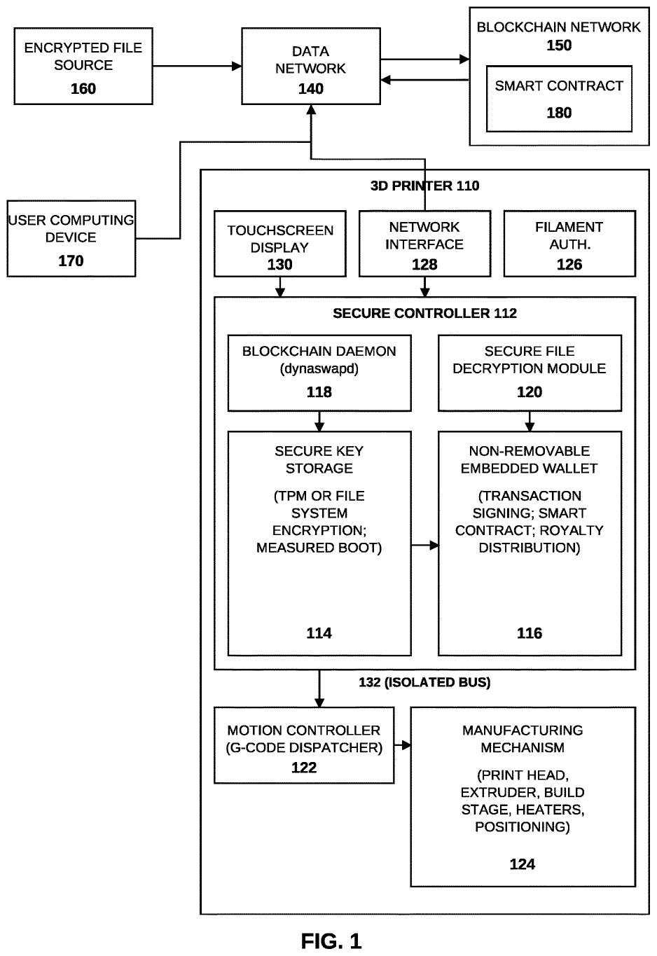

Embodiments of the subject matter described herein may be understood by referring to FIGS. 1-3. Although the embodiments are described in the context of additive manufacturing, the embodiments described herein may also be implemented using any type of networked manufacturing technology including but not limited to networked subtractive manufacturing such as computer numerical control (CNC) systems, networked robotics and automation systems, networked formative and sheet manufacturing, and hybrid and advanced distributed manufacturing such as rapid liquid printing.

As used herein, the term “3D printer” or “3D printing” refers to any additive manufacturing device, method, and/or system that fabricates a three-dimensional physical object from a digital model by the successive addition of material under computer control, including without limitation devices employing fused filament fabrication, stereolithography, digital light processing, selective laser sintering, selective laser melting, binder jetting, material jetting, directed energy deposition, and continuous liquid interface production, and further including devices that deposit polymers, metals, ceramics, composites, biological materials, food materials, or construction materials. The terms “3D printer,” “additive manufacturing device,” and “additive manufacturing system” are used interchangeably herein.

As used herein, the term “blockchain” refers broadly to any distributed, shared, or replicated data structure or protocol in which records, transactions, or state transitions are committed to an append-only or cryptographically-finalized sequence that is agreed upon by a plurality of independently operated nodes under a consensus mechanism, and in which the integrity of prior records is enforced by cryptographic means including without limitation hash-chaining, Merkle trees, cryptographic accumulators, verifiable delay functions, threshold signatures, and successor or equivalent techniques. A blockchain as used herein is not limited to any particular topology and includes without limitation linear chain-of-blocks architectures, directed acyclic graph architectures, block-lattice architectures, hashgraph architectures, and any combination, variant, or successor thereof. A blockchain may be public, private, permissioned, permissionless, or consortium-operated, may be a base-layer protocol or a layer-two, sidechain, rollup, state channel, or analogous construct that settles to a base layer, and may operate under any consensus mechanism including without limitation proof of work, proof of stake, proof of history, proof of authority, delegated proof of stake, practical Byzantine fault tolerance and its variants, federated or committee consensus, and any hybrid or successor mechanism. A blockchain may be token-native, token-agnostic, or non-tokenized, and may include or exclude support for smart contracts, virtual machines, or other programmable execution environments. By way of non-limiting example, references herein to a blockchain include Solana, Ethereum, Bitcoin, Polygon, Avalanche, Arbitrum, Optimism, Base, Sui, Aptos, Hedera, IOTA, and any present or future distributed ledger protocol exhibiting the above characteristics.

As used herein, the term “network” refers broadly to any arrangement of two or more computing, communication, storage, or data-handling entities that are coupled, directly or indirectly, through any medium that permits the exchange of data, signals, messages, or commands among them. A network as used herein may employ any physical or logical transport, including without limitation wired transports such as Ethernet in any of its IEEE 802.3 variants, power-line communication, coaxial and fiber-optic media, and serial, parallel, or peripheral-bus interconnects used to couple independently addressable nodes; wireless transports such as IEEE 802.11 wireless local area networks in any present or future generation, Bluetooth and Bluetooth Low Energy, Zigbee, Z-Wave, Thread, Matter, ultra-wideband, LoRa, Sigfox, NB-IoT and other low-power wide-area technologies, cellular networks of any generation including without limitation 4G LTE, 5G, 6G and any successor, and satellite or low-earth-orbit communications; and any virtualized, software-defined, or overlay construct, including without limitation virtual private networks, software-defined wide-area networks, mesh networks, peer-to-peer networks, content-delivery networks, and blockchain networks as defined separately herein. A network as used herein is not limited by topology and includes without limitation point-to-point, star, ring, bus, tree, mesh, and fully-connected topologies, and is not limited by protocol stack and may carry data under TCP/IP in any version, UDP, QUIC, HTTP in any version, MQTT, CoAP, OPC UA, MTConnect, or any predecessor, successor, or proprietary protocol. The term “network” is not limited by geographic scope and includes personal-area, local-area, metropolitan-area, wide-area, and global-scale architectures, including the public Internet and private or hybrid variants thereof.

The disclosed embodiments integrate blockchain functionality with 3D printing to manage intellectual property rights and manufacturing permissions in additive manufacturing. The systems comprise an embedded cryptographic wallet, validation protocols, and smart contract mechanisms that together enable authorized, verifiable, and traceable production of 3D printed objects. By integrating blockchain functionality into the printer's hardware and control systems, the disclosed systems provide a manufacturing platform that protects creators' rights and supports distributed production.

The disclosed systems are configured to autonomously verify digital licenses through non-fungible tokens (NFTs) before initiating a print operation. This is achieved through an architecture that combines secure hardware elements, encrypted communications, and blockchain-based verification protocols. The systems may restrict or grant manufacturing capabilities based on the validated state of digital assets on the blockchain, and manage usage limits, royalty distributions, and incentive mechanisms for environmentally conscious material choices.

In various embodiments described below, this functionality is implemented through an embedded, secure controller running a secure operating system, a non-removable cryptocurrency wallet, a blockchain daemon for license validation, and a secure file decryption module. These components enable direct blockchain interaction for licensing, automated royalty processing, and secure print job management.

FIG. 1 illustrates a system architecture of a blockchain-integrated 3D printer 110 according to an embodiment. The printer 110 comprises a secure controller 112 hosting a blockchain daemon 118, a secure file decryption module 120, a secure key storage 114, and a non-removable embedded cryptographic wallet 116. The secure controller 112 is coupled to a motion controller 122 by an isolated communication bus 132, and the motion controller 122 drives a manufacturing mechanism 124 comprising a print head, an extruder, a build stage, one or more heaters, and a positioning system. The printer 110 further comprises a filament authentication subsystem 126, a network interface 128, and a touchscreen display 130. The printer 110 communicates with an encrypted file source 160 and a user computing device 170 through a data network 140, and participates in a blockchain network 150 that hosts one or more smart contracts 180.

In an embodiment, the secure controller 112 is implemented using a single-board computer such as a Raspberry Pi or a similar embedded computing platform running a secure Linux operating system, or alternatively using a dedicated embedded microcontroller or system-on-chip provisioned with equivalent secure-boot and isolated-execution capabilities. As used herein, the secure controller 112 may be implemented as an “embedded” controller, meaning a controller physically integrated into the printer 110 as a permanent, non-user-serviceable component dedicated to operation of the printer 110. In such embodiments, the secure controller 112 and the printer 110 function as a single integrated device rather than as a printer controlled by a separable host machine. In alternative embodiments, the secure controller 112 may be implemented as a physically separate secure module communicatively coupled to the printer 110 through a cryptographically authenticated interface, including without limitation a hardened appliance dedicated to one or more printers, a rack-mounted secure controller serving a cluster of printers, or a pluggable hardware security module that mates with a corresponding interface on the printer 110. In each case, the cryptographic binding among the secure controller 112, the embedded wallet 116, and the manufacturing mechanism 124 is preserved such that decrypted toolpath data cannot be intercepted or substituted between the secure controller 112 and the motion controller 122.

As used herein, the term “module” refers to a structural component comprising program instructions executing on one or more processors, dedicated hardware circuitry, firmware executing on a microcontroller or field-programmable gate array, an application-specific integrated circuit, a secure element or trusted execution environment configured to perform a defined function, or any combination of the foregoing, together with any memory, interfaces, and supporting infrastructure necessary for the module to perform its defined function. A module as used herein is a discrete structural element of the system in which it resides, identifiable by the function it performs and by the structural components that implement that function, and is not a generic placeholder for a function performed by unspecified means. By way of non-limiting example, a module may be implemented as a software component comprising program instructions stored in a non-transitory computer-readable medium and executed by one or more processors of the secure controller 112; as dedicated hardware circuitry physically integrated with a mainboard of the printer 110; as firmware executing within the secure key storage 114, within a dedicated secure microcontroller, or within a trusted execution environment of the secure controller 112; or as a distributed implementation in which different portions of the module execute on different processors, hardware elements, or trusted execution environments.

The touchscreen display 130 provides a local user interface for initiating print jobs, reviewing device state, and presenting authorization and error information to the user. The network interface 128 couples the secure controller 112 to the data network 140 and, through the data network 140, to the blockchain network 150, the encrypted file source 160, and the user computing device 170. Bidirectional data flows between the blockchain network 150, the encrypted file source 160, and the secure controller 112 enable real-time validation of licenses and on-chain management of print jobs.

The data network 140 may comprise any network as defined herein, including without limitation a local-area network, a wide-area network, a private network, the public Internet, or any hybrid thereof, and may provide physical-layer connectivity via wired, wireless, or virtualized transports. The blockchain network 150 may comprise any blockchain as defined herein, including without limitation a layer-one protocol, a layer-two scaling protocol, a rollup, a sidechain, a state channel, or any combination operating in parallel, and may comprise multiple blockchain networks accessed concurrently by the printer 110. The encrypted file source 160 may comprise a local storage device, a server accessible through the data network 140, a decentralized storage network, a licensing-service-hosted storage facility, an on-chain account, or any combination thereof. The user computing device 170 may comprise a mobile device, a desktop or laptop computer, a dedicated licensing terminal, a fleet-management service, or any other computing device from which print job requests may originate.

The secure key storage 114 stores credentials for the embedded wallet 116 and other cryptographic material used by the secure controller 112, and is configured to perform signing and key-unwrapping operations without exposing private key material to a requesting process. The secure key storage 114 may be implemented in software executed on the secure controller 112, in hardware physically integrated with a mainboard or enclosure of the printer 110, in hardware physically separate from but interfacing with the printer 110, in a facility remote from the printer 110 and accessed over a network, or in any combination of the foregoing. The secure key storage 114 may support one or more cryptographic algorithms, including without limitation ECDSA over the secp256k1, secp256r1, or other standardized curves, Edwards-curve algorithms including Ed25519 and Ed448, RSA and RSA-PSS in any key size, symmetric algorithms including AES in any of its modes and any key size, authenticated-encryption algorithms including AES-GCM, ChaCha20-Poly1305, and successor constructions, and post-quantum signature or key-encapsulation algorithms standardized by the National Institute of Standards and Technology or equivalent standards bodies. Each of the implementation classes described below may be employed alone or in combination with one or more of the others, including combinations in which different categories of cryptographic material are held in different classes of secure key storage, combinations in which a single key is split across multiple secure key storage elements using threshold secret-sharing or multi-party computation, and combinations providing primary and redundant secure key storage for fault tolerance.

In a software-implemented embodiment, the secure key storage 114 comprises a protected key store maintained by the secure controller 112 and protected by one or more of: file system encryption under a key derived from user credentials, device-unique identifiers, or a hardware root of trust; operating-system-provided keyring services configured with appropriate access controls; encrypted container files mounted only within privileged processes; and memory-resident key stores that are never written to persistent storage in plaintext form. Software-implemented embodiments may rely on the underlying operating system, hypervisor, or application isolation mechanisms for protection of the key material against extraction by other processes executing on the secure controller 112.

In an on-board hardware embodiment, the secure key storage 114 comprises a discrete hardware component physically integrated with a mainboard of the printer 110 or with the secure controller 112. Suitable on-board hardware components include trusted platform modules conforming to the Trusted Computing Group TPM 2.0 specification or any successor specification, secure microcontrollers providing hardware-isolated key storage with built-in cryptographic acceleration, discrete secure element integrated circuits of the type used in payment card, transit, and mobile device applications, secure enclaves integrated within an application processor including ARM TrustZone implementations, Intel Software Guard Extensions enclaves, AMD Secure Encrypted Virtualization regions, and Apple Secure Enclave Processors, and hardware root-of-trust devices incorporating a physically unclonable function that generates device-unique keys from random variations in the manufacturing process. In on-board hardware embodiments, the secure key storage 114 is configured to generate its constituent private key internally such that the private key never exists outside the secure key storage 114 in plaintext form, and to perform signing and key-unwrapping operations without exposing the private key to the requesting process.

In an external hardware embodiment, the secure key storage 114 comprises a hardware security module physically separate from a main enclosure of the printer 110 and coupled to the secure controller 112 through a hardware interface. Suitable external form factors include Universal Serial Bus dongles, FIDO2 and WebAuthn-compliant security keys, hardware cryptocurrency wallets, smart cards inserted into a reader interface, secure digital or microSD cards containing an embedded secure element, subscriber identity module cards and embedded subscriber identity modules, custom-keyed card-edge modules mating with a corresponding receptacle on the printer 110, and cryptographic coprocessors mounted on daughterboards, modular carriers, or M.2, PCIe, or Mini-PCIe accessory slots. External hardware embodiments may be permanently seated in the printer 110, removably seated in the printer 110, hot-swappable during operation of the printer 110, or carried by a user and inserted only at the time of print authorization. External hardware embodiments may be activated by a biometric factor, a personal identification number, a proximity factor, a time-based factor, or any combination thereof, and may incorporate a local user interface for presentation of prompts and collection of the activation factor.

In a distributed or networked embodiment, the secure key storage 114 comprises a remote hardware security module, a cloud-based key management service, or a distributed key storage facility to which the secure controller 112 connects over the data network 140 or over a separate management network. The secure controller 112 authenticates to the remote or cloud-based secure key storage 114 using credentials established at initial provisioning, and requests signing or key-unwrapping operations from the remote facility rather than performing them locally. Distributed embodiments include embodiments in which the constituent private key of the embedded wallet 116 is split across multiple secure key storage elements using a threshold secret-sharing scheme such that signing or unwrapping operations require cooperation of a quorum of the elements, embodiments in which the signing operations are performed by a multi-party computation protocol distributed across the multiple elements such that the full private key is never reconstructed at any single location, and embodiments in which an on-board or external secure key storage holds one share of a key while one or more remote facilities hold the remaining shares.

The secure key storage 114 may be bound to the printer 110 physically, cryptographically, or both. Physical binding, where employed, is effected by one or more of: encapsulating the secure key storage 114 in epoxy potting material prior to final assembly; mounting the secure key storage 114 beneath a tamper-responsive mesh electrically monitored by an intrusion detection circuit, such that interruption of the mesh causes the secure key storage 114 to zeroize its key material; mounting the secure key storage 114 in a ball grid array or other surface-mount package beneath additional components requiring destructive rework to access; seating the secure key storage 114 in a receptacle sealed by a tamper-evident adhesive, a one-way mechanical latch, a pin-sheared retention clip, or a destructive locking mechanism; and housing the secure key storage 114 within an enclosure of the printer 110 such that access requires destructive disassembly. Physical binding is applicable to on-board hardware embodiments, to external hardware embodiments in which the hardware security module is seated and then sealed in its receptacle, and to any hybrid arrangement in which a component intended to be physically separable is converted into a physically non-separable component after initial provisioning.

Cryptographic binding, where employed, is effected by a pairing protocol executed at initial provisioning of the printer 110, at replacement of the secure key storage 114, or at any other provisioning event. During the pairing protocol, the secure key storage 114 and the secure controller 112 exchange and store attestations of each other's public keys, device-unique identifiers, or both. A cryptographically bound secure key storage 114 refuses to perform cryptographic operations for any secure controller other than the secure controller 112 with which it was originally paired, and may be further configured to erase or cryptographically invalidate its key material upon detection of an attempted coupling with a non-paired secure controller, upon detection of a configured number of failed authentication attempts, upon detection of physical tamper events, or upon receipt of a remote revocation command transmitted over the data network 140 or over the blockchain network 150. Cryptographic binding permits a secure key storage 114 to be physically removable or physically separable without permitting the cryptographic identity of the embedded wallet 116 to be transferred to another device, because the secure key storage 114 will not perform cryptographic operations for any device other than the printer 110 with which it was paired.

Physical and cryptographic binding may be combined in any arrangement. By way of non-limiting example, a secure key storage 114 may be seated in a receptacle of the printer 110, cryptographically paired with the secure controller 112, and then physically sealed in the receptacle after pairing, such that physical removal requires destructive rework and any hardware successfully removed still cannot be used on a different printer. Embodiments omitting both physical and cryptographic binding are also contemplated, in which the secure key storage 114 is a generic hardware security module freely transferable between printers and the embedded wallet 116 is bound to the printer 110 by mechanisms other than the secure key storage 114 hardware. As used herein, the embedded wallet 116 is described as “non-removable” in the sense that the cryptographic identity of the embedded wallet 116 cannot be transferred from the printer 110 to any other device, irrespective of whether every hardware component of the embedded wallet 116 is physically integrated into the printer 110 or whether one or more components are physically discrete from and cryptographically paired to the printer 110.

Embodiments may include primary and redundant secure key storage 114 elements for fault tolerance and recovery. In a redundant embodiment, the constituent private key of the embedded wallet 116 is stored in, or reconstructible from, two or more secure key storage 114 elements that are independently bound to the printer 110, such that failure or destruction of any one element does not destroy the cryptographic identity of the embedded wallet 116. Redundant embodiments may employ identical or heterogeneous implementations among the redundant elements, including combinations of on-board hardware, external hardware, and networked secure key storage. Recovery mechanisms for loss or destruction of the secure key storage 114 include rekeying protocols executed against a blockchain-recorded recovery authority, social recovery schemes distributing recovery shares among trusted parties, and provisioning of replacement secure key storage elements through a licensed manufacturer or authorized service provider. The secure key storage 114 may be further configured to rotate one or more keys held therein on a configured schedule, upon occurrence of configured events, or upon command, with previous keys retained for verification of previously-signed data as appropriate.

In an embodiment, the secure controller 112 performs a measured boot sequence in which a hardware root of trust computes cryptographic hashes of each stage of firmware loaded during boot and extends those hashes into platform configuration registers associated with the secure key storage 114. The values of the platform configuration registers are used by the secure key storage 114 as an authorization policy for releasing wrapped keys. A wrapped decryption key may be released by the secure key storage 114 only when the platform configuration register values match a reference set of values corresponding to unmodified, authorized firmware. Modification of the firmware of the printer 110 by an attacker therefore renders the wrapped keys unrecoverable on that device, even if the secure key storage 114 is physically intact.

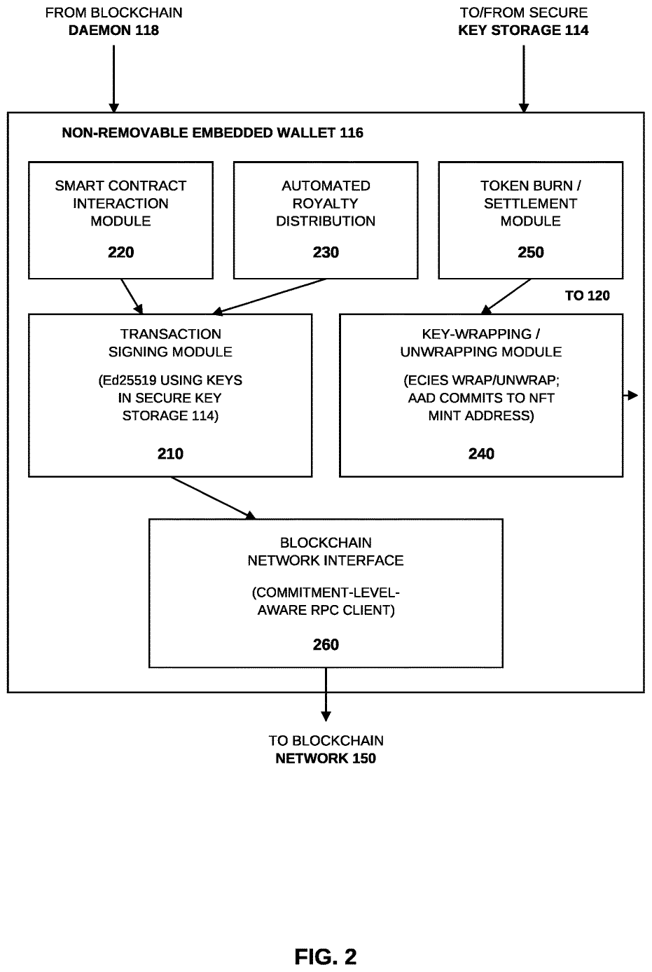

The embedded wallet 116 is integrated with and bound to the secure controller 112, maintains its credentials within the secure key storage 114, and is configured to participate directly in the blockchain network 150 for license validation, royalty distribution, and smart contract interaction. The architectural details of the embedded wallet 116, including its transaction signing module, smart contract interaction module, automated royalty distribution module, key-wrapping and unwrapping module, token burn and settlement module, and blockchain network interface, are described below with reference to FIG. 2.

The blockchain daemon 118, referred to in an embodiment as dynaswapd, operates within the secure controller 112 and validates NFT-based print licenses through interactions with the blockchain network 150 before authorizing print operations. In an embodiment, the blockchain daemon 118 is implemented in the Rust programming language, runs on the secure Linux operating system of the secure controller 112, and maintains a connection to a Solana remote procedure call network to perform on-chain verification. The blockchain daemon 118 interfaces with the embedded wallet 116 to sign and dispatch blockchain transactions, with the secure file decryption module 120 for encrypted file management, and with the motion controller 122 through a G-code dispatcher to release validated manufacturing operations for execution. The blockchain daemon 118 handles bidirectional on-chain interactions including license verification, royalty payments, token burn operations, and eco-incentive processing.

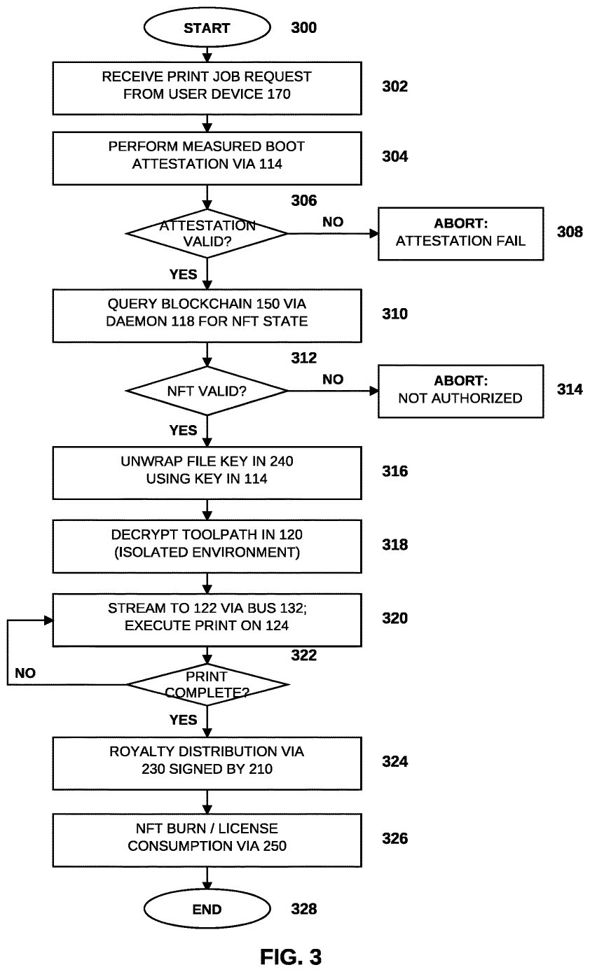

In an embodiment, the blockchain daemon 118 exists in a command-line interface based implementation that demonstrates core functionality including file authentication, blockchain validation, and mock manufacturing output capabilities. This implementation serves as a proof-of-concept for management of manufacturing permissions and digital rights through blockchain integration. The runtime behavior of the blockchain daemon 118, including its on-chain verification protocol, its handling of mid-print changes in license state, and its deferred-settlement operation under intermittent connectivity, is described below with reference to FIG. 3.

The secure file decryption module 120 operates within an isolated execution environment of the secure controller 112 and is configured to decrypt encrypted manufacturing files into a memory region that is inaccessible to a host operating system of the secure controller 112. Suitable isolated execution environments include secure enclaves of a trusted execution environment such as ARM TrustZone, memory regions controlled by a dedicated secure microcontroller, and memory regions within the secure key storage 114. The structure of the encrypted manufacturing files processed by the secure file decryption module 120, and the cryptographic binding between a manufacturing file and its governing license NFT, are described below with reference to FIG. 2.

Decrypted toolpath data produced by the secure file decryption module 120 is streamed to the motion controller 122 over the isolated communication bus 132, which does not traverse the host operating system's kernel or userspace. Suitable isolated communication buses include dedicated serial peripheral interface and inter-integrated circuit buses between the isolated execution environment and the motion controller 122. This architecture prevents capture of decrypted toolpath data by processes executing under the host operating system, including potentially compromised host processes. The motion controller 122 consumes the streamed toolpath data and drives the manufacturing mechanism 124 to execute the print operation.

The network interface 128 provides physical-layer and link-layer connectivity between the secure controller 112 and the data network 140 and may be implemented using wired transports, wireless transports, or a combination thereof.

In an embodiment, the printer 110 further comprises the filament authentication subsystem 126, which is configured to verify one or more properties of filament loaded into the printer 110 and to produce cryptographic attestations regarding the verified properties. In one implementation, a filament spool carries a near field communication tag storing a digitally signed certificate issued by a filament manufacturer, the certificate identifying the filament material composition, lot number, and biodegradability class, and being signed by a private key held by the filament manufacturer. The filament authentication subsystem 126 reads the tag through a near field communication reader and verifies the signature against a public key for the filament manufacturer, which public key may be enrolled in a registry maintained by the printer 110 or recorded on the blockchain network 150.

In a further implementation, the filament authentication subsystem 126 comprises a near-infrared spectroscopy sensor positioned in the filament path, and the secure controller 112 is configured to classify the filament material by comparing a measured spectrum of the filament against a library of reference spectra for authorized materials, the reference library being signed by a trusted authority and verifiable by the secure controller 112. In a further implementation, filament is classified by analysis of extrusion-pressure and melt-viscosity signatures captured during an initial extrusion phase and compared against reference signatures. The filament authentication subsystem 126 may employ any one or any combination of the foregoing mechanisms.

Upon successful verification of filament as belonging to an eco-incentivized class, the embedded wallet 116 signs an attestation of the verified filament use and submits an on-chain transaction to a smart contract 180 configured to distribute an eco-incentive reward to the user's wallet. The attestation includes the filament identifier, the quantity of filament consumed, the identifier of the print job, and the slot, block, or equivalent ordinal at which the attestation was generated, and is signed using a key held in the secure key storage 114 such that the attestation cannot be forged by a modified host.

FIG. 2 illustrates the internal architecture of the embedded wallet 116 according to an embodiment. The wallet 116 is configured to participate directly in the blockchain network 150 on behalf of the printer 110 and comprises a transaction signing module 210, a smart contract interaction module 220, an automated royalty distribution module 230, a key-wrapping and unwrapping module 240, a token burn and settlement module 250, and a blockchain network interface 260. The secure key storage 114, described above with reference to FIG. 1, serves as the cryptographic key store of the embedded wallet 116. Although the secure key storage 114 is shown in FIG. 1 at the level of the secure controller 112 rather than inside the boundary of the embedded wallet 116, the embedded wallet 116 comprises the secure key storage 114 by functional integration and exclusive use, regardless of the physical or logical placement of the secure key storage 114 within the printer 110. Accordingly, references in the following paragraphs to key material “held in,” “released by,” or “bound to” the secure key storage 114 identify the same cryptographic resource whether the secure key storage 114 is implemented as software on the secure controller 112, as on-board hardware, as external hardware physically discrete from the printer 110 but cryptographically paired with it, as networked or distributed key storage, or as any combination thereof as described in the preceding paragraphs.

The embedded wallet 116 is configured to act as a first-class cryptographic participant in the blockchain network 150, capable of originating, signing, and submitting transactions on behalf of the printer 110 without intermediation by a host computing device or an external licensing service. Commands directing the embedded wallet 116 to initiate blockchain transactions are received from the blockchain daemon 118 described above with reference to FIG. 1 and are distributed among the business-logic modules 220, 230, and 250. Transactions produced by those modules are dispatched to the transaction signing module 210 for signing under a key held in the secure key storage 114 and are then forwarded to the blockchain network interface 260 for submission to the blockchain network 150.

The transaction signing module 210 is configured to produce digital signatures over transaction data constructed by one or more of the smart contract interaction module 220, the automated royalty distribution module 230, and the token burn and settlement module 250. In an embodiment, the transaction signing module 210 performs signing using an Ed25519 key held in the secure key storage 114, in which the signing key is generated within the secure key storage 114 at initial provisioning and is never exposed outside the secure cryptographic boundary of the secure key storage 114. In alternative embodiments, the transaction signing module 210 performs signing using any of the cryptographic algorithms enumerated in the description of the secure key storage 114 above, including without limitation ECDSA over secp256k1, ECDSA over secp256r1, RSA-PSS, BLS signatures, Schnorr signatures, or a post-quantum signature algorithm, to accommodate deployment on blockchain networks employing different signing schemes. The transaction signing module 210 may be further configured to perform deterministic signature construction, to include anti-replay nonces or recent blockhashes in the signed payload, to produce signatures conforming to any transaction serialization format required by the blockchain network 150, to support hierarchical deterministic key derivation for generation of multiple signing keys from a single seed, to participate in multi-signature signing protocols in which transactions require signatures from a configurable quorum of signing authorities, and to support session-key or delegation-key architectures in which short-lived signing authority is delegated from a long-term key held in the secure key storage 114.

The smart contract interaction module 220 is configured to construct instruction data for invocation of one or more smart contracts 180 deployed on the blockchain network 150. In an embodiment directed to deployment on a Solana blockchain network, the smart contract interaction module 220 constructs Solana Program instructions identifying the target program, the accounts to be passed to the program, and the instruction-specific data payload. In alternative embodiments directed to deployment on an Ethereum Virtual Machine-compatible blockchain network, the smart contract interaction module 220 constructs function-call data encoded according to the contract Application Binary Interface, including function selector and encoded arguments, and may invoke functions conforming to token standards such as ERC-20, ERC-721, ERC-1155, ERC-2981, or any successor or equivalent standards. The smart contract interaction module 220 may further construct transaction envelopes appropriate to the target blockchain, including without limitation populating recent blockhashes, nonces, gas or compute-unit limits, priority fees, blob or data availability parameters, and account reference lists. The smart contract interaction module 220 is blockchain-agnostic in the sense that the same architectural role may be instantiated for any blockchain network hosting programmable contracts, including those encompassed by the broad definition of “blockchain” set forth above, and may be instantiated multiple times in parallel within a single embedded wallet 116 to enable simultaneous interaction with a plurality of blockchain networks.

The automated royalty distribution module 230 is configured to construct transactions that distribute payment among a plurality of recipients in accordance with a royalty policy associated with a print operation. In an embodiment, the royalty policy is encoded in the metadata of the license NFT governing the print operation and identifies each recipient by blockchain address together with a share of the total payment, expressed as a fraction, percentage, fixed amount, tiered allocation, or combination thereof. The automated royalty distribution module 230 reads the royalty policy at the commencement of the settlement phase of a print operation, constructs one or more transactions effecting the corresponding transfers, and submits the transactions to the transaction signing module 210 for signing and subsequent dispatch. In an alternative embodiment, the royalty policy is encoded in a smart contract 180 that receives a single payment from the automated royalty distribution module 230 and autonomously redistributes the payment among the recipients according to the policy, such that the automated royalty distribution module 230 need only construct a single funding transaction. In a further embodiment, the royalty policy is encoded according to a standardized royalty-information interface such as ERC-2981 or any successor standard, and the automated royalty distribution module 230 queries the standard interface to determine recipient and amount at the time of settlement. The automated royalty distribution module 230 supports royalty policies with any number of recipients, fixed or variable share allocations, and conditional distributions including without limitation jurisdiction-dependent payouts, time-weighted allocations reflecting contribution schedules, and tiered distributions triggered by cumulative print volume, sale price, geographic region, or any other parameter recordable on-chain or determinable from on-chain state. The plurality of recipients may include without limitation a primary creator, one or more collaborating creators, a platform operator, and a distributor.

In an embodiment, the smart contract 180 governing royalty distribution, the smart contract 180 governing settlement, or both, are operated under the governance of a decentralized autonomous organization, and governance authority over one or more policy parameters of the smart contract 180 is vested in the decentralized autonomous organization rather than in a single administrative principal. Policy parameters subject to decentralized autonomous organization governance include without limitation the identities and share allocations of royalty recipients, the rates and eligibility criteria for eco-incentive distributions, the schedule of fees accruing to a platform treasury, the reference metadata values against which a license NFT is validated, the configurable maximum offline interval enforced in deferred-settlement mode, the reference firmware configurations accepted at measured-boot attestation, the registry of public keys of authorized filament manufacturers, the registry of public keys of authorized printer wallets, and any other parameter of the smart contract 180 whose configurability is desired. Membership of the decentralized autonomous organization may comprise any combination of creators, licensees, printer operators, platform stakeholders, filament manufacturers, and other participants, and governance actions may be effected by on-chain voting, by delegation, by quadratic or conviction-weighted voting mechanisms, or by any other governance mechanism implementable as a smart contract. The automated royalty distribution module 230, the token burn and settlement module 250, and the key-wrapping and unwrapping module 240 interact with the smart contract 180 without distinction as to whether the policy parameters of the smart contract 180 are set by a single administrator or by a decentralized autonomous organization, such that the architecture of the embedded wallet 116 supports either governance model without modification.

In an embodiment, a smart contract 180 governing royalty distribution or license settlement is configured to reject a settlement transaction unless the transaction is signed by a wallet that has been registered on-chain as an authorized printer wallet, thereby preventing unauthorized entities from triggering burn or royalty operations without having performed an actual manufacturing operation. Registration of an embedded wallet 116 as an authorized printer wallet may require submission of a TPM attestation quote proving that the embedded wallet 116 exists within a genuine secure key storage 114 and that the firmware of the printer 110 is in an authorized state.

The token burn and settlement module 250 is configured to construct transactions that consume, decrement, or otherwise mark-as-used a license NFT upon completion of a print operation, thereby enforcing usage limits encoded in the NFT or in its governing smart contract 180. In an embodiment directed to single-use licenses, the token burn and settlement module 250 constructs a burn transaction that destroys the NFT, rendering it incapable of authorizing further prints. In an embodiment directed to multi-use licenses with a bounded usage count, the token burn and settlement module 250 constructs a usage-decrement transaction that reduces an on-chain counter associated with the NFT or transitions the NFT through a state machine encoded in its governing smart contract. In a further embodiment, the token burn and settlement module 250 constructs a usage-record transaction that appends an immutable record of the print operation to an on-chain log associated with the NFT, without necessarily reducing a residual usage count, for audit and provenance purposes. In a further embodiment, the token burn and settlement module 250 effects a transfer of the license NFT to a terminal or “spent” wallet address controlled by the smart contract 180, economically equivalent to burning but preserving the NFT for historical reference. The specific settlement behavior for a given NFT is determined by the governing smart contract 180, which may implement any combination of burn, decrement, state transition, log-append, and terminal-transfer semantics.

The blockchain network interface 260 is configured to dispatch signed transactions produced by the transaction signing module 210 to the blockchain network 150 through one or more blockchain network nodes and to receive confirmation of transaction inclusion, finalization, and execution results. In an embodiment, the blockchain network interface 260 comprises a remote procedure call client configured to connect to one or more Solana validators or gateway nodes, to select from among available commitment levels including “processed,” “confirmed,” and “finalized,” and to adjust its confirmation-wait strategy based on the operational context of the transaction. In alternative embodiments suitable for other blockchain networks, the blockchain network interface 260 comprises a JSON-RPC client for Ethereum and Ethereum-compatible networks, a gRPC client for protocols supporting that interface, a WebSocket subscription client for receiving push notifications of transaction status, a peer-to-peer gossip participant communicating directly with validator nodes without an intermediate RPC service, or any other interface suitable for the blockchain network 150. The blockchain network interface 260 may further implement retry logic, transaction replacement under fee-bumping policies, failover between multiple blockchain network nodes, simultaneous submission to multiple blockchain network nodes for redundancy, and caching of recent blockchain state to reduce latency and RPC bandwidth for routine operations.

The key-wrapping and unwrapping module 240 is configured to unwrap the per-file symmetric decryption keys of encrypted manufacturing files using wrapping keys held in the secure key storage 114, and to deliver the unwrapped keys to the secure file decryption module 120 described above with reference to FIG. 1. In an embodiment, the key-wrapping and unwrapping module 240 operates in conjunction with the transaction signing module 210 to construct signed challenge messages establishing the printer 110's entitlement to receive the unwrapped key, and in conjunction with the blockchain network interface 260 to transmit and receive such challenge messages as required by the particular unwrapping protocol employed. The structure of the encrypted manufacturing files processed by the key-wrapping and unwrapping module 240, and the cryptographic binding between a manufacturing file and its governing license NFT, are described in the paragraphs that follow.

In an embodiment, an encrypted manufacturing file comprises a ciphertext payload produced by encrypting plaintext manufacturing data under a per-file symmetric key using an authenticated encryption algorithm, together with a wrapped copy of the per-file symmetric key and associated metadata. The plaintext manufacturing data may comprise a stereolithography (STL) file, G-code instructions, a sliced build representation in an intermediate format such as 3MF or AMF, a computer-aided design file, a mesh file, a voxel representation, a print queue file, or any other representation suitable for driving the manufacturing mechanism 124. In an embodiment, the authenticated encryption algorithm is AES-256 in Galois/Counter Mode (AES-256-GCM). In alternative embodiments, the authenticated encryption algorithm is AES in any other authenticated mode including CCM, SIV, or OCB, ChaCha20-Poly1305, XChaCha20-Poly1305, an authenticated-encryption-with-associated-data construction built from any suitable block cipher and message authentication code, or any successor authenticated encryption algorithm. The per-file symmetric key may be of any key length appropriate to the selected cipher, and a new per-file symmetric key may be generated for each encrypted manufacturing file, for each print operation, for each licensee, or according to any other key-rotation policy. The wrapped copy of the per-file symmetric key may be delivered together with the encrypted manufacturing file in a single file container, delivered in a separate file referenced by the encrypted manufacturing file, stored in a decentralized storage network such as IPFS, Arweave, or Filecoin and referenced by a content-addressed pointer in the NFT metadata, stored in an on-chain account controlled by a smart contract 180 associated with the license NFT, or retrieved via an application programming interface exposed by a licensing service.

The per-file symmetric key is wrapped under a key derivable from, or associated with, the license NFT that authorizes manufacture of the object encoded by the plaintext. In one implementation, the per-file symmetric key is wrapped using an elliptic curve integrated encryption scheme (ECIES) under a public key associated with the license NFT, where the corresponding private key may be held by a license-issuing authority and released upon on-chain proof of ownership by the requesting wallet 116, may be derived from the NFT itself via a deterministic derivation function, or may be held by a smart contract program and released through a program-derived authorization. In another implementation, the per-file symmetric key is split using a threshold secret-sharing scheme among two or more parties, which may include the license-issuing authority, the embedded wallet 116 of the printer 110, one or more escrow agents, and one or more smart contract programs, such that no single party alone can reconstruct the key and a specified quorum of parties must cooperate to reconstruct it. In a further implementation, the unwrapping key is held by a smart contract program deployed on the blockchain network 150, and the smart contract program issues a program-derived decryption authorization only upon successful verification of current NFT ownership by the requesting wallet 116. In a further implementation, the per-file symmetric key is wrapped under a key derived through a key agreement protocol executed between the embedded wallet 116 and the license-issuing authority at the time of print authorization, such that the per-file symmetric key need not be stored in wrapped form prior to the print authorization event. In a further implementation, the per-file symmetric key is wrapped under a key derived from the printer 110's cryptographic identity in combination with the license NFT's mint address, such that the wrapped key is usable only on the printer 110 to which the license was issued. In a further implementation, the per-file symmetric key is encrypted using a proxy re-encryption scheme, such that an initial wrapping performed for a first holder of the license NFT can be re-wrapped for a subsequent holder upon on-chain transfer of the NFT without re-encryption of the underlying ciphertext.

The embedded wallet 116 negotiates release of the unwrapping material by signing a challenge message including one or more of: a recent blockhash or equivalent freshness token of the blockchain network 150, the account identifier of the embedded wallet 116, the mint address of the license NFT, an identifier of the encrypted manufacturing file, and any additional parameters required by the particular unwrapping protocol. The challenge message is signed by the transaction signing module 210 using a key held in the secure key storage 114. The signed challenge message is dispatched to the party holding the unwrapping material, which may be a license-issuing authority accessible over the data network 140, a smart contract 180 accessible through the blockchain network 150, or a distributed set of parties holding shares of a split key. Upon successful verification of the signed challenge message and of the current on-chain ownership of the license NFT, the unwrapping material is released to the key-wrapping and unwrapping module 240 for use in unwrapping the per-file symmetric key.

In an embodiment, the binding between the encrypted manufacturing file and the license NFT is enforced by including, in the authenticated additional data field of the authenticated encryption algorithm, a commitment to the mint address of the license NFT, such that any attempt to decrypt the ciphertext in association with a different NFT fails the authentication check and prevents recovery of plaintext manufacturing data. In a further embodiment, the ciphertext is additionally bound to a specific printer 110 by including, in the authenticated additional data field, a commitment to the public key of the embedded wallet 116 of the printer 110, such that the encrypted manufacturing file can be decrypted only on the specific printer 110 authorized for that print operation. In further embodiments, the authenticated additional data field may include any combination of: the mint address of the license NFT; the public key of the embedded wallet 116; a print-operation identifier; a version identifier of the encrypted manufacturing file; a version identifier of the firmware of the secure controller 112 expected to perform the decryption; a serial number of the printer 110; a jurisdiction identifier for export-controlled or regulated articles; a timestamp or a valid-from and valid-until pair; a measured-boot attestation value expected to be present at the time of decryption; and any other metadata whose binding to the ciphertext is required by the license terms. Any modification of the associated values following encryption causes the authentication check to fail, preventing decryption and rendering the encrypted manufacturing file unusable with altered associations.

The key-wrapping and unwrapping module 240 may support the parallel existence of multiple wrapping schemes within a single printer 110 deployment, enabling the printer 110 to process encrypted manufacturing files produced under different licensing architectures without reconfiguration. The key-wrapping and unwrapping module 240 selects the appropriate unwrapping procedure for a given encrypted manufacturing file based on metadata accompanying the file, which metadata identifies the wrapping scheme, the party or parties responsible for release of the unwrapping material, the commitments included in the authenticated additional data, and any additional parameters required for the selected scheme. The key-wrapping and unwrapping module 240 may further be configured to validate the metadata against a policy configured at the printer 110, and to refuse to initiate an unwrapping operation when the metadata indicates a wrapping scheme, a release authority, or a commitment set that is not permitted by the policy, thereby permitting a printer operator to restrict the range of licensing architectures accepted by the printer 110.

FIG. 3 illustrates an NFT-gated authorization and manufacturing process 300 performed by the printer 110, according to an embodiment. The process 300 cryptographically binds the right to decrypt and manufacture a particular article to the current on-chain state of a license NFT, is performed substantially within the secure controller 112, and terminates in the execution of authorized toolpath data on the manufacturing mechanism 124 and in the autonomous settlement of royalty and consumption transactions on the blockchain network 150. The steps of the process 300 and the decision points thereof are depicted in FIG. 3 with 300-series reference numerals and are described in the paragraphs that follow. The ordering of steps shown in FIG. 3 is one of multiple operative orderings contemplated herein, and individual steps may be performed in parallel, in a different order, combined, subdivided, or omitted in various embodiments, provided that the cryptographic binding between on-chain authorization and off-chain manufacturing is preserved.

At step 302, the secure controller 112 receives a print job request identifying an encrypted manufacturing file to be printed and a license NFT purporting to authorize the print. In an embodiment, the print job request is received from the user computing device 170 over the data network 140 through the network interface 128 and comprises one or more of: a reference to the encrypted manufacturing file, the encrypted manufacturing file itself, the mint address of the license NFT, metadata associated with the license NFT, parameters of the print operation such as quantity, material selection, and quality profile, and a digital signature of the requesting party over the request. In alternative embodiments, the print job request is received through the touchscreen display 130 via local user interaction, from a queue maintained on the blockchain network 150 that the blockchain daemon 118 monitors for jobs addressed to the embedded wallet 116, from a peer printer in a distributed manufacturing deployment, from an automated fleet-management service, or from a smart contract 180 that has autonomously queued the job following a purchase event. The reference to the encrypted manufacturing file may resolve to a file stored locally on the secure controller 112, stored in the encrypted file source 160 accessible through the data network 140, stored in a decentralized storage network such as IPFS, Arweave, or Filecoin and referenced by a content-addressed pointer, or stored in an on-chain account controlled by a smart contract 180. Upon receipt of the request, the secure controller 112 retrieves the encrypted manufacturing file if it is not already present and extracts the mint address of the license NFT and any other metadata required for subsequent steps.

In an embodiment, the operations of the process 300 and the architecture of the embedded wallet 116 collectively support a blockchain-based manufacturing marketplace in which posting, fulfillment, and payment of print jobs occur through interactions with one or more smart contracts 180 without intermediation by a centralized platform operator. A posting transaction submitted to a marketplace smart contract 180 by a user computing device 170 identifies a print job specification, a price offered, a license NFT or a reference to a license to be issued upon fulfillment, and any additional parameters governing acceptance of the job, and the marketplace smart contract 180 records the posted job in an on-chain job queue. The embedded wallet 116 of the printer 110, through the blockchain daemon 118, monitors the marketplace smart contract 180 for jobs matching the printer 110's published capabilities and accepts a matching job by submitting an acceptance transaction that commits the printer 110 to fulfillment. Upon successful completion of the print at decision 322 of the process 300, the settlement operations of steps 324 and 326 distribute payment from an escrowed balance held by the marketplace smart contract 180 to the printer operator, to the creator or creators of the underlying design in accordance with the royalty policy, to a platform treasury, and to any additional recipients specified by the governing policy, and concurrently transition the license NFT through the burn, decrement, or state-transition semantics applicable to the license. Upon failure or abort of the print, the escrowed balance is returned to the user in whole or in part according to the terms of the marketplace smart contract 180, and the license NFT is returned to a pre-print state. Marketplace smart contracts 180 may further implement reputation tracking for printer operators, dispute resolution mechanisms, minimum-quality and maximum-turnaround guarantees backed by staked collateral, and any other marketplace mechanics implementable as smart contract logic, with the printer 110's participation in such mechanics effected through the same transaction signing module 210, smart contract interaction module 220, and blockchain network interface 260 used for license validation and settlement.

At step 304, the secure controller 112 performs a measured boot attestation through the secure key storage 114 to confirm that the firmware currently executing on the secure controller 112 matches a reference configuration authorized to perform cryptographic operations with the key material held in the secure key storage 114. The measured boot sequence is as described above with reference to FIG. 1 and produces one or more attestation values representing the integrity of the boot chain, the operating system kernel, the blockchain daemon 118, the secure file decryption module 120, and any other firmware components whose integrity is required for secure operation. In an embodiment, the attestation values are compared against a reference set of values provisioned into the secure key storage 114 at manufacture or at a subsequent authorized firmware update. In an alternative embodiment, the attestation values are transmitted to a remote attestation service over the data network 140 and evaluated against a remotely-maintained policy, with the remote attestation service returning a signed attestation of firmware validity that is consumed by subsequent steps. In a further embodiment, the attestation values are recorded on the blockchain network 150 by the blockchain daemon 118 to provide a tamper-evident audit trail of firmware states across the fleet of printers.

At decision 306, the secure controller 112 evaluates the measured boot attestation. If the attestation is valid, the process proceeds to step 310. If the attestation is invalid, the process proceeds to step 308, at which the print job is aborted with an attestation error and the user is notified through one or more of the touchscreen display 130, a response to the user computing device 170, and an on-chain record generated by the blockchain daemon 118. Embodiments may further respond to attestation failure by zeroizing the key material in the secure key storage 114, initiating a self-quarantine of the printer 110, and transmitting a tamper alert to a configured remote monitoring service. In embodiments in which the secure key storage 114 enforces an attestation-bound release policy directly, steps 304 and 306 are performed implicitly by the secure key storage 114 refusing to release wrapped keys when the platform configuration register values do not match the reference set, such that the explicit attestation check may be omitted from the process 300 and the attestation failure manifests as an unwrapping failure at a later step.

At step 310, the blockchain daemon 118 performs on-chain verification of NFT license ownership and smart contract license state by submitting one or more account-lookup queries to the blockchain network 150. In an embodiment directed to deployment on a Solana blockchain network, the blockchain daemon 118 submits the queries to the Solana remote procedure call network using a recent blockhash for replay resistance, queries the SPL Token account associated with the public key of the embedded wallet 116 for the specific NFT mint address identified in the metadata of the encrypted manufacturing file, and confirms that the token balance is at least one unit. The blockchain daemon 118 further queries the Metaplex Token Metadata program account for the NFT to verify that the metadata of the NFT is unchanged relative to a reference metadata commitment recorded in the encrypted manufacturing file or in its accompanying license descriptor. The blockchain daemon 118 accepts only account states with a commitment level of “confirmed” or “finalized,” thereby ensuring that the verified state has been incorporated into the blockchain ledger and is not subject to reorganization. In an embodiment, the blockchain daemon 118 requires a commitment level of “finalized” for high-value or regulated print operations and accepts “confirmed” for lower-value operations, the applicable threshold being configurable by the printer operator, by the license-issuing authority, or by the governing smart contract 180.

In an alternative embodiment directed to deployment on an Ethereum Virtual Machine-compatible blockchain network, the blockchain daemon 118 queries the token contract of the NFT using the standard ERC-721 or ERC-1155 balanceOf or ownerOf function, queries any associated royalty-information interface such as ERC-2981 to obtain royalty parameters, and queries any additional contract-specific state required by the license terms, including without limitation whitelists of authorized printers, revocation registries, and usage-count accumulators. The blockchain daemon 118 selects its confirmation policy based on the finality semantics of the target network, which may include a configured number of block confirmations, a beacon-chain finality signal, or a checkpoint signal from a layer-two rollup's settlement layer. In further alternative embodiments, the blockchain daemon 118 performs verification through light-client proofs that reduce reliance on remote RPC providers, through state proofs retrieved from archival nodes, through committee-signed attestations in permissioned blockchain networks, or through cross-chain verification protocols when the license NFT resides on a chain different from the chain on which settlement occurs. The blockchain daemon 118 may issue queries in parallel to multiple blockchain nodes for redundancy, may require concurring answers from a configurable quorum of nodes before accepting a verification result, and may fall back among multiple RPC providers upon detection of failures or anomalous responses.

In an embodiment, the verification performed at step 310 further comprises a freshness check in which the blockchain daemon 118 requires that the slot number, block number, or equivalent ordinal of the verified account state be within a bounded interval of the current slot or block, thereby preventing use of stale proofs of ownership. The bounded interval may be expressed in units of slots, blocks, time, or transaction sequence number, and may be configured by the printer operator, by the license-issuing authority, by the governing smart contract 180, or by a policy embedded in the encrypted manufacturing file. The freshness bound may be absolute, such as a fixed number of seconds or slots, or relative, such as a fraction of the remaining usage budget of the license, or context-dependent, such as tighter bounds during elevated-risk operational states detected by the printer 110 or by an external monitoring service.

At decision 312, the blockchain daemon 118 evaluates whether the NFT is owned by the embedded wallet 116, is of the expected type, is not expired, is not revoked, has residual usage entitlement, and otherwise satisfies the license terms required for the requested print operation. If all conditions are satisfied, the process proceeds to step 316. If any condition fails, the process proceeds to step 314, at which the print job is aborted with a not-authorized error and the user is notified through one or more of the channels described above. In an embodiment, decision 312 further evaluates programmable policies including without limitation geographic restrictions determined from a printer location attestation, temporal restrictions such as license valid-from and valid-until windows, material restrictions coordinated with the filament authentication subsystem 126, and quality or quantity restrictions drawn from the license metadata. Upon a failure at decision 312, the blockchain daemon 118 may record the failure on the blockchain network 150 for audit and fraud-detection purposes, subject to privacy constraints configured at the printer 110 or required by governing law.

Upon successful verification at decision 312, the blockchain daemon 118 produces a signed attestation indicating that verification succeeded at a specified slot, block, or ordinal, and binding the attestation to the mint address of the license NFT, the identifier of the encrypted manufacturing file, the public key of the embedded wallet 116, and a freshness token. In an embodiment, the blockchain daemon 118 requests the transaction signing module 210 to sign the attestation using a key held in the secure key storage 114. In an alternative embodiment, the blockchain daemon 118 signs the attestation directly using an attestation key held in the secure key storage 114 that is distinct from the transaction-signing key of the embedded wallet 116. The attestation is consumed by the key-wrapping and unwrapping module 240 at step 316 as an authorization input to unwrap the per-file symmetric key, and is retained in the secure key storage 114 or in an append-only local log for subsequent settlement operations, for reconstruction of the audit trail following intermittent connectivity, and for dispute resolution. In an embodiment, the attestation is additionally recorded on the blockchain network 150 at the time of its production, at the time of print completion, or in a batched submission covering multiple print operations, according to a configured policy balancing auditability against on-chain transaction cost.

At step 316, the key-wrapping and unwrapping module 240 unwraps the per-file symmetric decryption key of the encrypted manufacturing file using wrapping material held in, or released by, the secure key storage 114, with the mint address of the license NFT included as additional authenticated data in the unwrapping operation. The detailed mechanics of the unwrapping operation, including the alternative wrapping schemes supported, the challenge-response protocols for release of unwrapping material from remote authorities or smart contracts, and the additional authenticated data commitments binding the ciphertext to the printer 110 and to the print operation, are as described above with reference to FIG. 2. The attestation produced at step 312 is provided to the key-wrapping and unwrapping module 240 as an authorization input and, depending on the selected wrapping scheme, is transmitted to the release authority as proof of successful on-chain verification.

At step 318, the key-wrapping and unwrapping module 240 delivers the unwrapped per-file symmetric key to the secure file decryption module 120 through an intra-controller channel that does not expose the unwrapped key to the host operating system of the secure controller 112, and the secure file decryption module 120 decrypts the toolpath data of the encrypted manufacturing file into a memory region within the isolated execution environment of the secure controller 112. In an embodiment, the key delivery and decryption operations are performed within a single secure enclave or trusted execution environment such that the unwrapped key and the decrypted toolpath data never cross a trust boundary, and the unwrapped key is erased from memory immediately upon completion of the decryption operation. In alternative embodiments supporting streaming decryption of large manufacturing files, the key-wrapping and unwrapping module 240 maintains the unwrapped key within the isolated execution environment for the duration of the print operation, the secure file decryption module 120 decrypts successive blocks of the toolpath data as they are consumed by subsequent steps, and the unwrapped key is erased upon print completion or upon print abort.

At step 320, the secure file decryption module 120 streams the decrypted toolpath data to the motion controller 122 over the isolated communication bus 132 as described above with reference to FIG. 1, and the motion controller 122 drives the manufacturing mechanism 124 to execute the print operation. Embodiments support synchronous execution in which each block of decrypted toolpath data is transmitted upon completion of the preceding block, buffered execution in which a bounded window of toolpath data is maintained ahead of the motion controller 122 to accommodate network or processing jitter, and block-by-block execution in which individual motion commands are released to the motion controller 122 only upon satisfaction of per-block policy checks. The isolated communication bus 132 may carry additional metadata alongside the toolpath data, including without limitation per-block integrity checksums, sequence numbers, and authorization tokens that the motion controller 122 verifies before executing each block.

A manufacturing operation authorized by the process 300 may be of extended duration, during which the on-chain state of the authorizing license NFT could change. The process 300 addresses this condition in one or more of the following ways, individually or in combination. In a first embodiment, the license NFT is transferred, at the commencement of the print operation, from the user's wallet to a program-controlled escrow account associated with the governing smart contract 180, such that the NFT cannot be transferred to a third party during the print. Upon successful completion of the print at decision 322, the governing smart contract 180 transfers the NFT back to the user's wallet, optionally executing a token burn or usage-decrement operation at step 326. Upon failure or abort of the print, the governing smart contract 180 transfers the NFT back to the user's wallet without executing a usage decrement, preserving the license for a subsequent attempt. In a second embodiment, the license NFT remains in the user's wallet but is locked against transfer for the duration of the print by a program-enforced lock recorded on-chain, which lock prevents the user from transferring the NFT but permits the user to observe and audit its state. In a third embodiment, the blockchain daemon 118 performs periodic re-verification of NFT ownership at configured intervals during the print, and interrupts the print at step 320 if any re-verification fails. The interval between re-verification operations may be expressed in units of print layers, time, percentage of completion, transmitted toolpath bytes, or any combination thereof, and may be configured by the governing smart contract 180, by the license terms encoded in the NFT metadata, or by a printer-level policy, and may be adapted dynamically based on the risk profile of the print. Embodiments may combine two or more of the foregoing, including without limitation combining escrow with periodic re-verification to protect against both asynchronous transfer and latent policy changes.

At decision 322, the blockchain daemon 118 or the motion controller 122 determines whether the print operation is complete. If the print is not complete, the process loops to step 320 for continued execution of the print, subject to any periodic re-verification performed in accordance with the preceding paragraph. If the print is complete, the process proceeds to step 324. Completion may be determined by one or more of: consumption of all decrypted toolpath data by the motion controller 122, explicit completion signal from the manufacturing mechanism 124, successful completion of an end-of-print measurement or inspection routine, and affirmative user confirmation through the touchscreen display 130. Embodiments that distinguish between successful completion and aborted or failed completion may route aborted or failed prints to an alternative branch that optionally records the failure on the blockchain network 150 for audit purposes but does not execute the settlement operations of steps 324 and 326.

At step 324, the automated royalty distribution module 230 of the embedded wallet 116 constructs one or more transactions that distribute payment among a plurality of recipients in accordance with the royalty policy associated with the print operation, the transactions are signed by the transaction signing module 210 using a key held in the secure key storage 114, and the signed transactions are broadcast through the blockchain network interface 260 to the blockchain network 150. The detailed mechanics of royalty distribution, including the alternative sources and formats of the royalty policy, the use of standardized royalty-information interfaces, and the enumeration of conditional distribution variations, are as described above with reference to FIG. 2.

At step 326, the token burn and settlement module 250 of the embedded wallet 116 constructs a transaction that consumes, decrements, or otherwise marks-as-used the license NFT in accordance with the license terms, the transaction is signed by the transaction signing module 210, and the signed transaction is broadcast through the blockchain network interface 260 to the blockchain network 150. The detailed mechanics of NFT burn and settlement, including the alternative semantics of burn, decrement, state transition, log-append, and terminal transfer, are as described above with reference to FIG. 2. In an embodiment, the transactions of steps 324 and 326 are bundled into a single atomic multi-instruction transaction that executes all settlement operations together, such that partial settlement is prevented. In an alternative embodiment, the transactions of steps 324 and 326 are submitted independently with appropriate ordering constraints to accommodate blockchain networks that do not support atomic multi-instruction execution.

At step 328, the process 300 terminates. The secure controller 112 releases or erases any ephemeral state established for the print operation, including without limitation the unwrapped per-file symmetric key, the decrypted toolpath data, any buffered motion commands, and any provisional state in the wallet modules. The printer 110 returns to an idle state ready to process a subsequent print job request.

In an alternative embodiment of the process 300 suitable for deployments in which continuous network connectivity to the blockchain network 150 cannot be assumed, the blockchain daemon 118 operates in a deferred-settlement mode. In the deferred-settlement mode, verification attestations produced at step 312 are cached locally within the secure key storage 114 or in an append-only local log, and subsequent print operations proceed at steps 316 through 322 based on the cached attestations. Settlement transactions produced at steps 324 and 326 are queued and transmitted to the blockchain network 150 upon restoration of connectivity, with the queued transactions cryptographically signed at the time of their production so that they are resistant to forgery during the offline interval. A configurable maximum offline interval is enforced by the blockchain daemon 118 in cooperation with the secure key storage 114, such that cached attestations older than the configured interval are invalidated and further manufacturing operations are suspended until fresh on-chain verification is performed. The configurable maximum offline interval may be set by the governing smart contract 180, by the license-issuing authority, by the printer operator, or by any combination thereof, with the most restrictive applicable value controlling. Embodiments supporting deferred settlement may further implement an offline-grace mechanism in which a small number of print operations are permitted before fresh verification is required, may support a conservative mode in which only previously-printed articles may be reproduced offline and new articles require fresh verification, and may support an audit mode in which deferred settlement activity is disclosed to the license-issuing authority upon reconnection with sufficient detail to permit post-hoc verification.

The process 300 is robust to network interruption, power interruption, and other transient failures. In an embodiment, the state of the process 300 is persisted at configured checkpoint boundaries within the secure key storage 114 or in encrypted form within the secure controller 112, such that upon recovery from a transient failure, the secure controller 112 can resume the process 300 from the most recent checkpoint rather than restarting from step 302. Checkpoint persistence is coordinated with any mid-print ownership handling mechanism described above, such that upon resumption the secure controller 112 re-verifies any license state that may have changed during the failure interval before resuming execution at step 320. In an embodiment, the process 300 additionally supports clean cancellation of a print in progress, either upon user command through the touchscreen display 130 or upon detection of an off-chain condition warranting cancellation such as a recalled license or a regulatory stop-order, by transitioning to a cancellation branch that releases ephemeral state, optionally transfers any escrowed NFT back to the user's wallet without decrement, and records the cancellation on the blockchain network 150 for audit purposes.

The systems and methods described herein have applicability beyond additive manufacturing. The architectural elements described above, including the secure controller 112, the embedded wallet 116, the secure key storage 114, the blockchain daemon 118, the secure file decryption module 120, and the process 300, may be adapted to any digital manufacturing system in which encrypted design files require authorization-gated decryption and execution, including without limitation computer numerical control machining systems, automated assembly lines, laser cutting and engraving systems, industrial robotics systems, and hybrid or distributed manufacturing systems. The filament authentication subsystem 126 and associated eco-incentive mechanisms may be correspondingly adapted to alternative materials, consumables, or process inputs relevant to the selected manufacturing modality.

The systems and methods described herein may be embodied in a non-transitory computer-readable medium storing instructions that, when executed by one or more processors of the secure controller 112, cause the secure controller 112 to perform the operations of the blockchain daemon 118, the secure file decryption module 120, the embedded wallet 116 and its constituent transaction signing module 210, smart contract interaction module 220, automated royalty distribution module 230, key-wrapping and unwrapping module 240, token burn and settlement module 250, and blockchain network interface 260, and the process 300 of FIG. 3 including without limitation the measured boot attestation of steps 304 and 306, the on-chain verification of steps 310 and 312, the unwrapping and decryption operations of steps 316 and 318, the streaming and execution operations of step 320, the completion determination of decision 322, and the settlement operations of steps 324 and 326. Suitable non-transitory computer-readable media include without limitation solid-state storage such as NAND or NOR flash memory, dynamic or static random access memory configured for non-volatile retention, electrically erasable programmable read-only memory, magnetic storage media including hard disk drives and magnetic tape, optical storage media including CD-ROM, DVD, and Blu-ray Disc, internal storage of a trusted platform module or secure element, internal storage of a hardware security module physically or cryptographically paired with the printer 110, and any combination of the foregoing. The instructions may be stored in encrypted form and decrypted at load time using a key released by the secure key storage 114 only upon successful measured-boot attestation, such that unauthorized modification of the instructions renders them unexecutable. The non-transitory computer-readable medium may be physically integrated with the secure controller 112, physically separate from but cryptographically paired with the secure controller 112, hosted on the data network 140 and accessed by the secure controller 112 during firmware update, or any combination thereof.

While the systems and methods have been described in connection with a number of embodiments and implementations, these are not limiting but cover various apparent modifications and equivalent arrangements which fall within the purview of the appended claims. Although features are expressed in certain combinations among the claims, it is contemplated that these features can be arranged in any variety and order.

I claim:

1. A blockchain-integrated manufacturing system comprising:
a secure controller;
a non-removable embedded wallet integrated with said secure controller;
a blockchain daemon operatively associated with said secure controller and configured to validate non-fungible-token-based digital licenses through verification on a blockchain network;
a secure file decryption module configured to decrypt encrypted manufacturing files upon successful validation of said non-fungible-token-based digital licenses by said blockchain daemon;
a manufacturing mechanism configured to perform manufacturing operations; and
a motion controller coupled to said secure controller through an isolated communication bus and configured to drive said manufacturing mechanism based on a blockchain validation status determined by said blockchain daemon.

2. The system of claim 1, wherein said non-removable embedded wallet comprises:
a secure key storage configured to store cryptographic credentials of said non-removable embedded wallet;
a blockchain network interface;
a smart contract interaction module configured to construct and submit transactions to one or more smart contracts deployed on said blockchain network; and
an automated royalty distribution module configured to construct transactions distributing payment among a plurality of recipients in accordance with a royalty policy associated with a manufacturing operation.

3. The system of claim 2, wherein said secure key storage is implemented through at least one of file system encryption of a protected key store maintained by said secure controller, or a trusted platform module.

4. The system of claim 2, wherein said secure key storage comprises a hardware security module physically separate from a main enclosure of said system and coupled to said secure controller through a hardware interface, said hardware security module being cryptographically paired with said secure controller at initial provisioning such that said hardware security module refuses to perform cryptographic operations for any secure controller other than said secure controller with which said hardware security module was originally paired.

5. The system of claim 1, wherein said blockchain daemon comprises:
a remote procedure call client configured to connect to a remote procedure call network of said blockchain network;
non-fungible-token validation logic configured to verify said non-fungible-token-based digital licenses;
an encrypted file management module; and
an automated token operations module configured to track usage of said non-fungible-token-based digital licenses.

6. The system of claim 5, wherein said blockchain network is a Solana blockchain network and said remote procedure call network is the Solana remote procedure call network.

7. The system of claim 1, further comprising a filament authentication subsystem configured to verify one or more properties of a filament loaded into said manufacturing mechanism, wherein said non-removable embedded wallet is further configured to submit to a smart contract on said blockchain network an on-chain transaction distributing an eco-incentive reward upon successful verification of said filament as belonging to an eco-incentivized class.

8. The system of claim 1, wherein said non-removable embedded wallet further comprises a token burn and settlement module configured to, upon completion of a manufacturing operation authorized by said blockchain daemon, construct and submit a transaction to said blockchain network effecting an operation selected from the group consisting of burning said non-fungible-token-based digital license, decrementing an on-chain usage counter associated with said non-fungible-token-based digital license, and transferring said non-fungible-token-based digital license to a terminal wallet address controlled by a smart contract.

9. A method for blockchain-validated manufacturing performed by a blockchain-integrated manufacturing system comprising a secure controller, a non-removable embedded wallet integrated with said secure controller, and a manufacturing mechanism, the method comprising:
receiving, by said secure controller, an encrypted manufacturing file and a reference to a non-fungible-token-based digital license;
validating, by a blockchain daemon operatively associated with said secure controller, said non-fungible-token-based digital license through verification on a blockchain network;
decrypting, by said secure controller, said encrypted manufacturing file upon successful validation of said non-fungible-token-based digital license;
executing, by said manufacturing mechanism, a manufacturing operation using decrypted toolpath data from said encrypted manufacturing file received from said secure controller over an isolated communication bus; and
processing, by said non-removable embedded wallet, an automated royalty payment through a smart contract deployed on said blockchain network.

10. The method of claim 9, further comprising tracking, by said secure controller, usage limits associated with said non-fungible-token-based digital license through on-chain token operations, and submitting an automated token burn transaction upon completion of said manufacturing operation.

11. The method of claim 9, further comprising verifying, by said secure controller, a property of a filament loaded into said manufacturing mechanism, and submitting by said non-removable embedded wallet an on-chain transaction distributing an environmental compliance incentive through a smart contract based on said verifying.

12. The method of claim 9, further comprising maintaining a secure record of said manufacturing operation by producing, by said blockchain daemon upon said validating, a signed attestation binding said manufacturing operation to a mint address of said non-fungible-token-based digital license, a public key of said non-removable embedded wallet, and an ordinal of said blockchain network at which said validating succeeded.

13. The method of claim 9, wherein said validating comprises submitting, by said blockchain daemon, at least one account-lookup query to said blockchain network and accepting only account states having a commitment level of confirmed or finalized.

14. The method of claim 9, further comprising, during execution of said manufacturing operation, performing, by said blockchain daemon, periodic re-verification of ownership of said non-fungible-token-based digital license at configured intervals and interrupting said manufacturing operation in response to failure of any re-verification.

15. A non-transitory computer-readable medium storing instructions that, when executed by one or more processors of a secure controller, cause said secure controller to:
validate a non-fungible-token-based digital license through on-chain verification on a blockchain network;
decrypt an encrypted manufacturing file upon successful validation of said non-fungible-token-based digital license;
direct a manufacturing mechanism to execute a manufacturing operation using decrypted toolpath data from said encrypted manufacturing file, said decrypted toolpath data being transmitted from said secure controller over an isolated communication bus;
submit to a smart contract deployed on said blockchain network a transaction effecting an automated royalty payment upon completion of said manufacturing operation; and
track permissions associated with said non-fungible-token-based digital license through on-chain token operations.

16. The non-transitory computer-readable medium of claim 15, wherein said instructions are stored in encrypted form and decrypted at load time using a key released from a secure key storage only upon successful measured-boot attestation of firmware of said secure controller.

17. The non-transitory computer-readable medium of claim 15, wherein said instructions further cause said secure controller to distribute said automated royalty payment among a plurality of recipients including at least two of a primary creator, a collaborating creator, a platform operator, and a distributor, in accordance with a royalty policy associated with said non-fungible-token-based digital license.

18. The non-transitory computer-readable medium of claim 15, wherein said instructions further cause said secure controller to verify a property of a filament loaded into said manufacturing mechanism and to submit to a smart contract on said blockchain network a transaction distributing an eco-incentive reward upon successful verification of said filament as belonging to an eco-incentivized class.

19. The non-transitory computer-readable medium of claim 15, wherein said instructions further cause said secure controller to, upon completion of said manufacturing operation, construct and submit to said blockchain network a transaction effecting an operation selected from the group consisting of burning said non-fungible-token-based digital license, decrementing an on-chain usage counter associated with said non-fungible-token-based digital license, and transferring said non-fungible-token-based digital license to a terminal wallet address controlled by a smart contract.

20. The non-transitory computer-readable medium of claim 15, wherein said instructions further cause said secure controller to operate in a deferred-settlement mode during periods of intermittent connectivity to said blockchain network, in which verification attestations produced upon successful validation of said non-fungible-token-based digital license are cached locally and settlement transactions are queued and transmitted to said blockchain network upon restoration of connectivity, subject to a maximum offline interval beyond which cached attestations are invalidated, said maximum offline interval being settable by at least one of a governing smart contract of said blockchain network, a license-issuing authority, and a printer operator.
